(19) United States
(12) Patent Application Publication
(10) Pub. No.: US 2021/0141245 A1
(43) Pub. Date: May 13, 2021

(54) EYEWEAR HAVING POLARIZERS

(71) Applicant: David Scott Andrews, Berkeley, CA (US)

(72) Inventor: David Scott Andrews, Berkeley, CA (US)

(21) Appl. No.: 16/677,365

(22) Filed: Nov. 7, 2019

(51) Int. Cl. G02C 7/12; G02B 5/30

(52) U.S. Cl. CPC G02C 7/12; G02B 5/3025

(57) ABSTRACT

Variable optical density ophthalmic devices. The ophthalmic device includes: a frame; a first pair of linearly polarizing filters fixedly mounted on the frame; a pair of rotating filter holders rotatably mounted on the frame; and a second pair of polarizing filters secured to the pair of rotating filter holders, respectively. The pair of rotating filter holders is configured to be individually rotated relative to the frame so that an amount of light that passes through one of the second pair of polarizing filters and goes to one eye is adjusted separately from an amount of light that passes through the other of the second pair of polarizing filters and goes to the other eye.

### BACKGROUND

### A. Technical Field

The present invention relates to eyewears, and more particularly, to variable optical density (OD) ophthalmic devices having multiple layers of polarizing filters.

### B. Background of the Invention

Polarization refers to the orientation of the waves of light around the propagation axis. The polarization of light can rotate 360 degrees without affecting the propagation direction, wavelength (color) or intensity of the light. Typically, sunglass lenses have laminated linear polarizing films or are formed of linearly polarized acrylic or glass lenses. In this context, “lens” refers to an optic in a pair of eyewear and may or may not have refractive power for correcting or enhancing vision in some way.

These polarized lenses attenuate light by allowing light waves of a specific polarization orientation, typically vertical, to pass through while blocking light waves of other polarization orientations. In general, light from a source like the sun reflect off a horizontal speculator reflector, such as water, car's windows or shiny paint at or near Brewster's angle, which is about 56 degrees for glass or 52 degrees for water, becomes S or horizontally polarized (S or Horizontal polarized light, in these conditions, will reflect at a higher rate than P or vertical polarization) so that vertically polarized eyeglasses eliminate glare from these types of reflections. Existing polarized sun glasses are almost always vertically (relative to the earth when the wearer is sitting or standing) and can block horizontally polarized light waves, they still may not be suitable for patients having certain eye disorders. For instance, binocular double vision or diplopia is a symptom that results when the mussels or nerves that control the mussels in one or both eyes are not fully functional and prevent the eyes from tracking together, resulting in two images that are not similar enough for the brain to combine them together and create the perception of a single image. Also problems in the way the brain process the image due to injury or disease can result in the symptom. Diplopia can be caused by lazy eye or amblyopia, diabetes, brain tumors and cancers, myasthenia gravis, multiple sclerosis, and head or eye injury.

The existing polarized lenses cannot block one eye or the other to eliminate the double vision. Currently, blocking one eye with an eye patch is an effective way of mitigating the symptom since the brain now receives an image from just one eye. However, the conventional eye patches have several problems. Sometimes, it is advantages to shift the eye that is being blocked several times through the day. In such a case, the tape on eye patch cannot be easily moved from one eye to the other. Also, when the patient wears a pirate style strap around his head, the strap can be knocked off or the patch may leak light if there is not a good fit, even though it can be moved from side to side. Finally, possibly the biggest problem with eye patches is that people don't wear because of aesthetics and cumbersomeness. Some adults suffer from incurable lifelong disorders and do not want wear a patch every day to work since the patch is visually advertising disability and disadvantageous to those who have frequent face-to-face interactions with people for business. Also, it may be advantageous to block just enough light in one eye so as to have the brain largely ignore the image but not block all the light so as to give the patient the best possible outcome allowing for some depth perception and some peripheral vision. Patients also like to control the amount of light to the unblocked eye to minimize glare and eye strain. Finally it may be good for the health of the “blocked” eye to have some light stimulation.

In another example, photo phobia is defined as the extreme sensitivity to light in one or both eyes and caused by optic neuritis (an infection of the optic nerve often caused by multiple sclerosis), concussion, migraines, infections inflammation or damage to the cornea or other parts of the eye. The existing polarized lenses have a fixed optical density and cannot adjust the amount of light to the eyes separately. Also, if only one eye is affected or one eye is affected much more than the other, the existing polarized lenses cannot adjust the attenuation of light to each eye individually as needed.

The conventional “transition” lenses that are made up of an optical coating to darken in the presence of UV light may not be suitable for the patient having the eye disorders. The conventional transition lenses do not allow the wearers to control the amounts of light that pass through. Also, the optical coating reacts the same for both eyes and does not work in an airplane or car cabin where the windshield blocks the sun's UV rays that are needed to activate or darken the coating. Moreover, the optical coating can achieve the OD of around 2 or 100× attenuation, which may not be sufficient for certain patients with the eye disorders.

In yet another example, airplane pilots and automobile drivers may want to incorporate a mono vision approach when driving or flying into the setting or rising sun. Similar to the contact lenses approach where one lens is set for near and one for far, the driver or pilot may want to set one eye to deal with looking into the bright sun and the other eye to deal with less attenuation for looking at the instrument panel. In such a case, the one eye may need more attenuation of light than the other eye. In still another example, sailor's and climbers, who are often forced to look into a harsh sun and deal with extreme glare off the snow or water, may need the ability to adjust the attenuation of light beyond what can be achieved through the available eyewears. Typically, the sailors and climbers may need to quickly readjust the attenuation to deal with near in tasks, like looking at navigation aids, rigging for sailor's oxygen controls, altimeters and personal rigging for climbers.

As such, there is a need for ophthalmic devices that are able to adjust the attenuation level of light to each eye individually to thereby enhance the vision.

### SUMMARY OF THE DISCLOSURE

In one aspect of the present invention, an ophthalmic device includes: a frame; a first pair of polarizing filters fixedly mounted on the frame (one for each eye); a pair of rotating filter holders rotatably mounted on the frame; and a second pair of polarizing filters secured to the pair of rotating filter holders, respectively. The pair of rotating filter holders is configured to be individually rotated relative to the frame so that an amount of light that passes through one of the second pair of polarizing filters and goes to one eye is adjusted separately from an amount of light that passes through the other of the second pair of polarizing filters and goes to the other eye.

In another aspect of the present invention, a two filter ophthalmic device contains a frame and other aspects of standard eye glasses. Each of the two lens openings in the eyewear frame front is circular and has the following system of filters and holders. One fixed filter holder contain a vertically oriented (when the wearer is sitting or standing) linear polarizing filter. This fixed filter holder has a rail that may extend in front of the fixed filter and follows the circular rotating filter holder. The rotating filter is mounted in the rotating filter holder which may have a V groove that allows the rotating filter holder to “snap in” to the rail of the fixed filer holder. A tab on the rotating holder containing the rotating filter can be pushed clockwise or counter clockwise, enabling the filter to rotate and cross with the fixed filter. For light entering normal to the filters, ˜34% of light may reach the eye when the polarization directions of the rotating and fixed filters are oriented parallel to each other. When the polarization directions of the rotating and fixed filters polarization axis are perpendicular to each other (the filters are said to be cross polarized), only ˜0.007% of the light entering normal to the filters may be allowed through.

In yet another aspect of the present invention, a three filter ophthalmic device exists within the circular frame front openings. A pair of fixed filter holders is incorporated into the eyewear frame or securely mounted to it. The pair of fixed filter holders and the pair of rings hold the two pairs of fixed vertically oriented (when the wearer is sitting or standing) linear polarizing filters. The pair of fixed filter holders and the pair of rings do not allow the two pairs of fixed filters to move and sandwich the pair of rotating filter holders that is allowed to rotate in between the two pairs of fixed filters. As each of the pair of rotating filters rotates, the rotating filter crosses with the orientation of the first entrance filter and the last exit filter that equally effectively attenuate randomly polarized light coming from the sun and/or most forms of indoor lighting. This System can achieve 2X the attenuation as the two filter ophthalmic device. When all three filters are arranged parallel to each other, ˜26% of light may reach the eye. When the two pairs of fixed filters are arranges perpendicular (i.e. crossed) to the rotating filter, ˜0.00049% of light may reach the eye.

In still another aspect of the present invention, the first fixed filter (farthest from the eye) in the three filter ophthalmic device may be replaced with a glass or acrylic optic which may or may not have refractive power for correcting vision (be a “prescription lens”). This optic may be vertically oriented linearly polarized similar to the fixe filter it replaces. The frame of the optometric device has a pair of v-grooves for mounting the pair of lenses therein, and each pair of V grooves may have a notch for insuring the front optic does not rotate in the mount and is rotationally oriented correctly. Each of the pair of optics may have a refractive power for correcting vision and may have a convex curved front surface. Each of the pair of front lenses may have various coatings, such as scratch resistant coating, antireflective coating and UV blocking coating.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a perspective view of an ophthalmic device according to embodiments of the present disclosure.

FIG. 2 shows a side view of the ophthalmic device in FIG. 1 according to embodiments of the present disclosure.

FIG. 3 shows a rear view of the ophthalmic device in FIG. 1 according to embodiments of the present disclosure.

FIG. 4 shows a perspective view of the ophthalmic device in FIG. 1 according to embodiments of the present disclosure.

FIG. 5A shows a partial cutaway view of the ophthalmic device in FIG. 1 according to embodiments of the present disclosure.

FIG. 5B shows an enlarged side view of a portion of the ophthalmic device in FIG. 5A according to embodiments of the present disclosure.

FIG. 6 shows a perspective view of an ophthalmic device according to embodiments of the present disclosure.

FIG. 7 shows a front view of the ophthalmic device in FIG. 6 according to embodiments of the present disclosure.

FIG. 8 shows a rear view of the ophthalmic device in FIG. 6 according to embodiments of the present disclosure.

FIG. 9A shows a partial cutaway view of the ophthalmic device in FIG. 6 according to embodiments of the present disclosure.

FIG. 9B shows an enlarged view of a portion of the ophthalmic device in FIG. 9A according to embodiments of the present disclosure.

FIG. 10 shows an exploded view of the ophthalmic device in FIG. 6 according to embodiments of the present disclosure.

FIG. 11 shows a perspective view of an ophthalmic device in according to embodiments of the present disclosure.

FIG. 12 shows a side view of the ophthalmic device in FIG. 11 according to embodiments of the present disclosure.

FIG. 13 shows an exploded view of the ophthalmic device in FIG. 11 according to embodiments of the present disclosure.

FIG. 14A shows a partial cutaway view of the ophthalmic device in FIG. 11 according to embodiments of the present disclosure.

FIG. 14B shows an enlarged view of a portion of the ophthalmic device in FIG. 14A according to embodiments of the present disclosure.

FIG. 15A shows a rear view of the left eye cup in FIG. 11 according to embodiments of the present disclosure.

FIG. 15B shows a top view of the left eye cup in FIG. 11 according to embodiments of the present disclosure.

FIG. 15C shows a perspective view of the left eye cup in FIG. 11 according to embodiments of the present disclosure.

FIG. 16A shows a rear view of the right eye cup in FIG. 11 according to embodiments of the present disclosure.

FIG. 16B shows a top view of the right eye cup in FIG. 11 according to embodiments of the present disclosure.

FIG. 16C shows a perspective view of the right eye cup in FIG. 11 according to embodiments of the present disclosure.

FIG. 16D shows an enlarged view of a portion of the right eye cup in FIG. 16C according to embodiments of the present disclosure.

FIG. 17 shows a side view of the right eye cup in FIG. 11 according to embodiments of the present disclosure.

FIG. 18A shows a cross sectional view of the right eye cup in FIG. 17, taken along the line 18A-18A according to embodiments of the present disclosure.

FIG. 18B shows an enlarged view of a portion of the right eye cup in FIG. 18A according to embodiments of the present disclosure.

### DETAILED DESCRIPTION OF THE PREFERRED EMBODIMENTS

In the following description, for the purposes of explanation, specific details are set forth in order to provide an understanding of the invention. It will be apparent, however, to one skilled in the art that the invention can be practiced without these details. One skilled in the art will recognize that embodiments of the present invention, described below, may be performed in a variety of ways and using a variety of means. Those skilled in the art will also recognize additional modifications, applications, and embodiments are within the scope thereof, as are additional fields in which the invention may provide utility. Accordingly, the embodiments described below are illustrative of specific embodiments of the invention and are meant to avoid obscuring the invention.

A reference in the specification to “one embodiment” or “an embodiment” means that a particular feature, structure, characteristic, or function described in connection with the embodiment is included in at least one embodiment of the invention. The appearance of the phrase “in one embodiment,” “in an embodiment,” or the like in various places in the specification are not necessarily all referring to the same embodiment.

Referring to Figures below, the variable optical density ophthalmic devices are depicted as, without limitation intended, eyeglasses. However, it is to be understood that the mechanisms and designs of the eyeglasses can be implemented in other suitable ophthalmic devices, such as goggles, and such are comprehended within the scope of the invention. Also, the eyeglasses are depicted to have the steampunk style. However, it should be apparent to those of ordinary skill in the art that the eyeglasses may have other suitable design.

### Two Filter Ophthalmic Device—Steampunk Style

FIG. 1 shows a perspective view of an ophthalmic device 100 according to embodiments of the present disclosure. FIG. 2 shows a side view of the ophthalmic device 100 according to embodiments of the present disclosure. FIG. 3 shows a rear view of the ophthalmic device 100 according to embodiments of the present disclosure. FIG. 4 shows a perspective view of the ophthalmic device 100 according to embodiments of the present disclosure. FIG. 5A shows a partial cutaway view of the ophthalmic device 100 according to embodiments of the present disclosure. FIG. 5B shows an enlarged side view of the ophthalmic device 100 according to embodiments of the present disclosure.

As depicted, the ophthalmic device 100 may include: a frame 104 having a pair of fixed filter holders 110a and 110b, a pair of frame front lens mounting rings (or shortly rings) 130a and 130b containing the pair of fixed filter holders 110a and 110b, respectively, and a bridge 108 connected to the pair of rings 130a and 130b; a pair of end pieces 106a and 106b connected to the pair of rings 130a and 130b, respectively; a pair of temple arms 102a and 102b connected to the pair of end pieces 106a and 106b, respectively; and a pair of nose pads 107a and 107b connected to the pair of rings 130a and 130b, respectively. (In FIG. 4, the pair of temple arms 102a and 102b and the pair of nose pads 107a and 107b are not shown.) In embodiments, the pair of fixed filter holders 110a and 110b may be snapped into the pair of rings 130a and 130b, respectively. (Hereinafter, the terms filter and lens are used interchangeably since a lens may contain a polarizing film.)

The ophthalmic device 100 further include: a pair of rotating filters 114a and 114b; a pair of rotating filter holders 112a and 112b that are rotatably mounted on the pair of fixed filter holders 110a and 110b, respectively, where the pair of rotating filters 114a and 114b is secured to the pair of rotating filter holders 112a and 112b, respectively; and a pair of fixed filters 122a and 122b that are secured to the pair of fixed filter holders 110a and 110b, respectively. In embodiments, a pair of disk-shaped tabs (or protrusions) 116a and 116b is formed on the pair of rotating filter holders 112a and 112b, respectively.

In embodiments, each of the filters 114a, 114b, 122a and 122b may be a linearly polarized lens that has a linearly polarizing film sandwiched in a laminating material like cellulose triacetate or a glass and may (or may not) have a prescription for correcting vision. The pair of rotating filters 114a and 114b may be adjustable or rotatable and may have their axes of polarization oriented in the vertical or horizontal or somewhere in-between (polarized in a first direction) when the wearer is sitting or standing. In embodiments, the pair of fixed filters 122a and 122b may have their fixed axes of polarization in the vertical orientation when the wearer is sitting or standing.

In embodiments, when the axis of polarization of the pair of rotating filter 114a and 114b is also in vertical direction, there is a maximum amount of light getting through the fixed and rotating filters. Typically, the light that reflects off of horizontal surfaces becomes predominantly horizontally polarized and the device 100 may minimize this source of glare similar to the conventional sun glasses. When filter 114A and 114B are rotated away from vertical and towed horizontal, they may begin attenuating light by blocking the polarization (orientation of light waves) that would pass through the pair of fixed filters 122A and 122B. When the axis of polarization of the pair of rotating filters 114a and 114b becomes perpendicular or crossed to the pair of fixed filters 122a and 122b, a minimum amount of light gets through and a maximum attenuation is achieved by the fixed and rotating filters.

In embodiments, the pair of rotating filter holders 112a and 112b may be formed of suitable material, such as plastic or metal, for securing the pair of rotating filters 114a and 114b thereto, respectively. In embodiments, each of the pair of rotating filters 114a and 114b may form an integral part of the corresponding rotating filter holders. As shown in FIGS. 5A and 5B, each of the pair of rotating filter holders (e.g. 112b) may have a substantially circular ring shape and rotatably secured to the corresponding fixed filter holder 110b by a tongue-and-groove joint, i.e., the rotating filter holder 112b includes a groove 140 that is formed along its circumferential direction and receives the ring-shaped rail (or tongue) 141 formed along the circumferential direction of the fixed filter holder 110b. In embodiments, user may push the tab (or protrusion) 116b to rotate the rotating filter holder 112b (and the rotating filter 114b) in the clockwise or counterclockwise direction relative to the fixed filter holder 110b (and the frame 104). In embodiments, the rail 140 may snugly fit into the groove 141 so that the rotating filter holder 112b does not slide relative to the fixed filter holder 110b when the user does not operate the tab 116b.

In embodiments, the pair of fixed filter holders 110a and 110b may be formed of suitable material, such as plastic or metal, and the pair of fixed filters 122a and 122b may be fixedly secured to the pair of fixed filter holders 110a and 110b, respectively (and the frame 104). As discussed above, the user may rotate each rotating filter holder (e.g. 112b) relative to the corresponding fixed filter holder 110b (and the frame 104) while the fixed filter 122b is fixedly secured to the fixed filter holder 110b (and the frame 104). As such, as the user rotates the rotating filter holder 112b, the rotating filter 114b is rotated relative to the fixed filter 122b. Since each of the rotating and fixed filters is polarized along a predetermined direction, the user may adjust the amount of light passing through both filters. For instance, when the polarization direction of the rotating filter 114b is aligned parallel to the polarization direction of the fixed filter 122b, the amount of the light passing through the two filters may be at its maximum. Likewise, when the polarization direction of the rotating filter 114b is aligned perpendicular to the polarization direction of the fixed filter 122b, the two filters are crossed, substantially blocking most of the light to the left eye, i.e., attenuation is maximized and transmition is minimized.

By way of example, when the polarization direction of the rotating filter 114b is aligned parallel to the polarization direction of the fixed filter 122b, about 34% of the light that is randomly polarized and incident on the front surface of the rotating filter passed through both the rotating and fixed filters. When the polarization direction of the rotating filter 114b is aligned perpendicular to the polarization direction of the fixed filter 122b, about 0.007% of the light incident on the front surface of the rotating filter may pass through both the rotating and fixed filters.

In embodiments, each rotating filter holder 112a (or 112b) may be rotated so that the angle between the polarization directions of the rotating and fixed filters may range from 0 to at least 90 degrees so that the maximum and minimum attenuation can be reached. Stated differently, by rotating the rotating filter holder 112a (or 112b) relative to the frame 104, an optical density of 0.4 to 4.15 and an optical dynamic range of 5000:1 may be obtained. In embodiments, when if only one eye of the wearer is affected or one eye is affected much more than the other, the wearer of the ophthalmic device 100 can adjust the attenuation level of each eye separately as needed.

It is noted that the user may be able to rotate each of the pair of rotating filter holders 112a and 112b individually so that the amount of light to each eye is adjusted separately. For instance, a patient suffering from diplopia may wear the eyeglass 100 and rotate one or more of the pair of rotating filter holders 112a and 112b separately to block one eye or the other to eliminate the double vision. Also, the user may be able to shift the eye that is being blocked by rotating the pair of rotating filter holders 112a and 112b separately.

For some patients suffering photo phobia, the light sensitivity may come and go, and this symptom may be only in one eye or in both eyes or switch back and forth. In embodiments, all the variability makes the ophthalmic device 100, which includes quickly adjustable cross polarized eyeglasses, the perfect tool to block the right amount of light in each eye.

In embodiments, each of the pair of fixed filter holders (e.g. 110b) may have indicators 120 that are arranged along the circumferential direction of the fixed filter holder 110b and each tab (e.g. 116b) may include an indicator groove 118. In embodiments, each indicator 120 may indicate the amount of light that passes through the rotating and fixed filters when the indicator groove 118 is aligned with the indicator.

Three Filter Ophthalmic Device—without Prescription Lens and without Eye Cup

FIG. 6 shows a perspective view of an ophthalmic device 200 according to embodiments of the present disclosure. FIG. 7 shows a front view of the ophthalmic device 200 according to embodiments of the present disclosure. FIG. 8 shows a rear view of the ophthalmic device 200 according to embodiments of the present disclosure. FIG. 9A shows a partial cutaway view of the ophthalmic device 200 according to embodiments of the present disclosure. FIG. 9B shows an enlarged view of a portion of the ophthalmic device 200 in FIG. 9A according to embodiments of the present disclosure. FIG. 10 shows an exploded view of the ophthalmic device 200 according to embodiments of the present disclosure.

As depicted, the ophthalmic device 200 may include: a frame 204 having a pair of semi-circular rings 209a and 209b, a pair of fixed filter holders 210a and 210b secured to the pair of semi-circular rings, respectively, a bridge 208 connected to the pair of semi-circular rings 209a and 209b, and a pair of rings 230a and 230b secured to the pair of fixed filter holders 210a and 210b, respectively; a pair of temple arms 202a and 202b connected to the frame 204; and a pair of nose pads 207a and 207b connected to the frame 204.

The ophthalmic device 200 further include: a first pair of fixed filters 214a and 214b that are fixedly secured to the pair of fixed filter holder 210a and 210b, respectively; a pair of rotating filter holders 212a and 212b that are rotatably mounted on the pair of fixed filter holders 210a and 210b, respectively; a pair of rotating filters 222a and 222b that are fixedly secured to the pair of rotating filter holders 212a and 212b, respectively; and a second pair of fixed filters 215a and 215b that are fixedly secured to the pair of rings 230a and 203b, respectively. In embodiments, a pair of disk shaped handles (tabs) 216a and 216b may be formed on the pair of rotating filter holders 212a and 212b, respectively.

In embodiments, each of the filters 214a, 214b, 215a, 215b, 222a, and 222b, may be a linearly polarized lens that has a linearly polarizing film sandwiched in a laminating material like cellulose triacetate or a glass and may (or may not) have a prescription for correcting vision. The first and second pairs of fixed filters 214a, 214b, 215a and 215b may be stationary (i.e., may not rotate relative to the frame 204) and polarized in a first direction, such as the vertical orientation when the wearer is sitting or standing, so as to absorb the light that is polarized in a horizontal direction. The pair of rotating filters 222a and 222b may be adjustable or rotatable and may have their axes of polarization oriented in the vertical or horizontal or somewhere in-between (polarized in a second direction) when the wearer is sitting or standing. In embodiments, the polarization direction of the first pair of fixed filters 214a and 214b may be aligned parallel to the polarization direction of the second pair of fixed filters 215a and 215b. In embodiments, the first pair of fixed filters 214a and 214b may include other types of coating, such as anti-reflection coating, scratch-resistance coating, and/or ultraviolet (UV) blocking coating to meet the required UV A and UV B blocking specifications and may also contain prescription lenses.

In embodiments, the pair of rotating filter holders 212a and 212b may be formed of suitable material, such as plastic or metal, for securing the pair of rotating filters 222a and 222b thereto, respectively. In embodiments, the pair of rotating filters 222a and 222b may form an integral part of the pair of rotating filter holders 212a and 212b, respectively. In embodiments, user may push the tab (e.g. 216b) to rotate the rotating filter holder 212b (and the rotating filter 222b) relative to the fixed filter holder 210b (and the frame 204). In embodiments, each fixed filter holder 210b (or 210a) may have a slot 211b (or 211a), where each tab (e.g. 216b) may travel along the slot (e.g. 211b) when the user pushes the tab 216b to rotate the rotating filter holder 212b relative to the fixed filter holder 210b.

In embodiments, the pair of rings 230a and 230b may be formed of suitable material, such as plastic or metal, and the second pair of fixed filters 215a and 215b may be fixedly secured to the pair of rings 230a and 230b, respectively. As discussed above, the user may rotate each rotating filter holder (e.g. 222b) relative to the frame 204 while the first fixed filter 214b and second fixed filter 215b are fixedly secured to the frame 204. As such, when the user rotates the rotating filter holder 212b, the rotating filter 222b is rotated relative to the first and second fixed filters 214b and 215b so as to adjust the amount of light passing through the three filters (first fixed filters, second fixed filter and rotating filter).

In embodiments, the polarization direction of the first fixed filter 214a (or 214b) may be aligned parallel to the polarization direction of the second fixed filter 215a (or 215b). As such, when the polarization direction of the first fixed filter 214a (or 214b) is aligned parallel to the polarization direction of the rotating filter 222a (or 222b), the amount of the light passing through the three filters (i.e., first fixed filter, second fixed filter and rotating filter) may be at its maximum. Likewise, when the polarization direction of the first fixed filter 214a (or 214b) is aligned perpendicular to the polarization direction of the rotating filter 222a (or 222b), the three filters may substantially block the light to the left eye. Stated another way, the polarization of the pair of rotating filters 222a and 222b in the middle may be crossed with the pair of fixed filters 214a and 214b (the input fixed filters) and crossed with the pair of fixed filter 215a and 215b (the output or “clean up” fixed filter). By way of example, when all three filters are arranged parallel to each other, ˜26% of light may reach the eye. When the two pairs of fixed filters are arranges perpendicular (i.e. crossed) to the pair of rotating filters, ˜0.00049% of light may reach the eye.

In embodiments, the angle between the polarization directions of the fixed and rotating filters may determine the amount of light that passes through the three filters. In embodiments, the length of the slot 211a (and 211b) along its circumferential direction is long enough so that the angle between the polarization directions of the rotating and fixed filters ranges from 0 to at least 90 degrees so as to reach the maximum and minimum attenuations.

It is noted that the user may be able to rotate each of the pair of rotating filter holders 212a and 212b individually so that the amount of light to each eye is adjusted separately. For instance, a patient suffering from diplopia may wear the eyeglass 200 and rotate one of the pair of rotating filter holders 212a and 212b individually to block one eye or the other to eliminate the double vision. Also, the user may be able to shift the eye that is being blocked by rotating the pair of rotating filter holders 212a and 212b separately. In embodiments, the ophthalmic device 200 may be used to block enough light in the eyes of the patients suffering from photo phobia.

In embodiments, each of the pair of fixed filter holders 210a and 210b may have indicators (similar to the indicators 120 in FIG. 4, and not shown in FIGS. 6-10) that are arranged along its circumferential direction, and each of the pair of tabs 216a and 216b may include an indicator groove (similar to the groove 118 in FIG. 4, and not shown in FIGS. 6-10). In embodiments, the indicators and indictor grooves formed in the ophthalmic device 200 may have the similar functions as the indicators 120 and indictor grooves 118 formed in the ophthalmic device 100.

### Three Filter Ophthalmic Device Having Prescription Lenses and Eye Cups

In embodiments, the ophthalmic devices 100 and 200 may not include a prescription lens. In embodiments, some of the linearly polarized filters of the ophthalmic devices 100 and 200 may be replaced with prescription lenses (or optics), where the prescription lenses may or may not have polarization coatings or a substrate that has polarizing properties. FIG. 11 shows a top perspective view of an ophthalmic device 300 according to embodiments of the present disclosure. FIG. 12 shows a side view of the ophthalmic device 300 according to embodiments of the present disclosure. FIG. 13 shows an exploded view of the ophthalmic device 300 according to embodiments of the present disclosure. FIG. 14A shows a partial cutaway view of the ophthalmic device 300 according to embodiments of the present disclosure. FIG. 14B shows an enlarged view of a portion of the ophthalmic device 300 according to embodiments of the present disclosure.

As depicted, the ophthalmic device 300 may be similar to the ophthalmic device 200, with the differences that the first pair of fixed filters 214a and 214b may be replaced with a pair of prescription lenses 314a and 314b and that a pair of cups (or side shields) 336a and 336b is mounted on a pair of output fixed filter rings (or shortly rings) 330a and 330b

As depicted, the ophthalmic device 300 may include: a frame 304 having a pair of lens holders 309a and 309b, a bridge 308 connected to the pair of lens holders 309a and 309b, and the pair of rings 330a and 330b secured to the pair of lens holders, respectively; a pair of temple arms 302a and 302b connected to the frame 304; and a pair of nose pads 307a and 307b connected to the frame 304. The pair of prescription lenses 314a and 314b may be mounted on the pair of lens holders 309a and 309b, respectively. In embodiment, the pair of lens holders 309a and 309b may have v-grooves 370, where the pair of prescription lenses 314a and 314b may be mounted therein. Each of the pair of prescription lenses 314a and 314b may have a refractive power for correcting vision and be formed of suitable material, such glass, for instance. In embodiments, each of the pair of prescription lenses 314a and 314b may have a convex curved front surface.

The ophthalmic device 300 may further include: a pair of rotating filter holders 312a and 312b that is rotatably mounted on the pair of lens holders 309a and 309b, respectively; a pair of rotating filters 315a and 315b that is fixedly secured to the pair of rotating filter holders 312a and 312b, respectively; and a pair of fixed filters 322a and 322b that is fixedly secured to the pair of rings 330a and 303b, respectively. In embodiments, a pair of disk-shaped handles (tabs) 316a and 316b is formed on the pair of rotating filter holders 312a and 312b, respectively.

In embodiments, each of the filters 315a, 315b, 322a, and 322b may be a linearly polarized lens that has a linearly polarizing film sandwiched in a laminating material like cellulose triacetate or a glass. The pair of fixed filters 322a and 322b may be stationary (i.e., may not rotate relative to the frame 304) and polarized in a first direction, such as the vertical orientation when the wearer is sitting or standing, so as to absorb the light that is polarized in a horizontal direction. The pair of rotating filters 315a and 315b may be adjustable or rotatable and may have their axes of polarization oriented in the vertical or horizontal or somewhere in-between (polarized in a second direction) when the wearer is sitting or standing. In embodiments, the pair of prescription lenses 314a and 314b may include various types of coating, such as polarization coating, scratch-resistance coating, anti-reflection coating or ultraviolet (UV) blocking coating to meet the required UV A and UV B blocking specifications.

In embodiments, the pair of rotating filter holders 312a and 312b may be formed of suitable material, such as plastic or metal, for securing the pair of rotating filters 315a and 315b thereto. In embodiments, each of the pair of rotating filters 315a and 315b may form an integral part of the corresponding rotating filter holder. In embodiments, the user may push the tab 316b (or 316a) to rotate the rotating filter holder 312b (or 312a) relative to the frame 304 (or, more specifically, lens holder 309b). In embodiments, each lens holder 309b (or 309a) may have a slot 311b (or 311a), respectively, where each tab (e.g. 316b) may travel along the slot (e.g. 311b) as the user pushes the tab 316b to rotate the rotating filter holder 312b relative to the lens holder 309b.

In embodiments, the pair of rings 330a and 330b may be formed of suitable material, such as plastic or metal, and the pair of fixed filters 322a and 322b may be fixedly secured to the pair of rings 330a and 330b, respectively. As discussed above, the user may rotate each rotating filter holder (e.g. 312b) relative to the corresponding lens holder 309b while the fixed filter 322b is fixedly secured to the ring 330b. As such, as the user rotates the rotating filter holder 312b, the rotating filter 315b is rotated relative to the fixed filter 322b. Since each of the rotating and fixed filters is polarized along a predetermined direction, the user may adjust the amount of light passing through the rotating and fixed filters.

In embodiments, when the polarization direction of the rotating filter (e.g. 315b) is aligned parallel to the polarization direction of fixed filter 322b, the amount of the light passing through the rotating and fixed filters may be at its maximum. Likewise, when the polarization direction of the rotating filter 315b is aligned perpendicular to the polarization direction of the fixed filter 322b, the rotating and fixed filters may substantially block the light to the left eye. In embodiments, the angle between the polarization directions of the rotating and fixed filters may determine the amount of light that passes through the rotating and fixed filters. In embodiments, the length of the slot 311a (and 311b) along its circumferential direction is long enough so that the angle between the polarization directions of the rotating and fixed filters ranges from 0 to at least 90 degrees to reach the maximum and minimum attenuations.

It is noted that the user may be able to rotate each of the pair of rotating filter holders 312a and 312b individually so that the amount of light to each eye is adjusted separately. For instance, a patient suffering from diplopia may wear the eyeglass 300 and rotate one or more of the rotating filter holders 312a and 312b separately to block one eye or the other to eliminate the double vision. Also, the user may be able to shift the eye that is being blocked by rotating the rotating filter holders 312a and 312b separately.

In embodiments, each of the pair of lens holders 309a and 309b may have indicators (similar to the indicators 120 in FIG. 4, and not shown in FIGS. 11-14) that are arranged along its circumferential direction and each of the tabs 316a and 316b may include an indicator groove (similar to the indicator groove 118 in FIG. 4, and not shown in FIGS. 11-14). In embodiments, the indicators and indicator grooves formed in the ophthalmic device 300 may have the similar functions as the indicators 120 and indictor grooves 118 formed in the ophthalmic device 100.

The design of ophthalmic devices for patients with photo phobia may differ in that the ophthalmic devices need to seal tightly against the face and eye sockets to block out all the light that might get to the eyes without passing through the lenses in front. FIG. 15A shows a rear view of the left eye cup (or side shield) 336a in FIG. 11 according to embodiments of the present disclosure. FIG. 15B shows a top view of the left eye cup 336a according to embodiments of the present disclosure. FIG. 15C shows a perspective view of the left eye cup 336a according to embodiments of the present disclosure. FIG. 16A shows a rear view of the right eye cup 336b in FIG. 11 according to embodiments of the present disclosure. FIG. 16B shows a top view of the right eye cup 336b according to embodiments of the present disclosure. FIG. 16C shows a perspective view of the right eye cup 336b according to embodiments of the present disclosure. FIG. 16D shows an enlarged view of a portion of the right eye cup 336b according to embodiments of the present disclosure.

In embodiments, the pair of cups 336a and 336b may protect the eyes from any debris as well as the light that might get to the eyes without passing through the lenses in front. As depicted in FIGS. 15B and 16B, the cups may be contoured to seal tightly against the wearer's face and eye sockets. In embodiments, the pair of cups 336a and 336b may be formed of plastic or other suitable material that can block the light. In embodiments, each cup may include a groove 338 that engages the protrusion formed on the corresponding ring 330a (or 330b) so that each cup may be detachably mounted on the ring by a tongue-and-groove joint.

FIG. 17 shows a side view of the right eye cup 336b according to embodiments of the present disclosure. FIG. 18A shows a cross sectional view of the right eye cup 336b, taken along the line 18A-18A according to embodiments of the present disclosure. FIG. 18B shows an enlarged view of a portion of the right eye cup 336b in FIG. 18A according to embodiments of the present disclosure. As depicted, the wall of the right eye cup 336b may have light-tight air vents (or shortly vents) 342 that allow air to pass therethrough and prevent the light from passing through the cups, to thereby prevent condensation of moisture on the surfaces of the filters/lenses in the ophthalmic device 300. It is noted that the pair of cups 336a and 336b may be also detachably mounted on the ophthalmic devices 100 and 200 by tongue-and-groove joints.

In embodiments, as discussed above, the ophthalmic devices 100, 200 and 300 may allow the wearers with diplopia to effectively block one eye or the other, eliminating the double vision. This may be preferred over a conventional eye patch since the wearers may want to allow both eyes to work at different times and stay strong. Also, in embodiments, there may be a level of attenuation that eliminates the double vision but does not leave the heavily attenuated eye completely useless for detecting objects that is out of the field of vision of the un-attenuated eye.

In general, conventional transition coating may achieve up to an optical density 2 or 100× attenuation on a bright sunny day. In embodiments, the ophthalmic devices 100, 200 and 300 may be able to achieve optical density of 3 to 6 or 1000 to 1,000,000×attenuation, depending on the number of filters and the angle of the filters on the face relative to the line of sight.

It is noted that the filters in FIGS. 1A-14B are shown to have a flat disk shape. However, it should be apparent to those filters may be curved so that both front and rear surfaces are concave to the eyes. This curvature may be employed to enhance overall performance by making the polarizer surface closer to normal for all the rays of light contained in the cone of light that can reach the eye.

While the invention is susceptible to various modifications and alternative forms, specific examples thereof have been shown in the drawings and are herein described in detail. It should be understood, however, that the invention is not to be limited to the particular forms disclosed, but to the contrary, the invention is to cover all modifications, equivalents, and alternatives falling within the scope of the appended claims.

What is claimed is:

1. An ophthalmic device, comprising:
a frame;
a first pair of polarizing filters fixedly mounted on the frame;
a pair of rotating filter holders rotatably mounted on the frame;
a second pair of polarizing filters secured to the pair of rotating filter holders, respectively; and
the pair of rotating filter holders being configured to be individually rotated relative to the frame so that an amount of light that passes through one of the second pair of polarizing filters and goes to one eye is adjusted separately from an amount of light that passes through the other of polarizing filters and goes to the other eye.

2. The ophthalmic device of claim 1, wherein the pair of rotating filter holders is rotatably mounted on the frame by tongue-and-groove joints.

3. The ophthalmic device of claim 1, wherein the frame includes a pair of fixed filter holders and wherein the first pair of polarizing filters are secured to the pair of fixed filter holders, respectively.

4. The ophthalmic device of claim 3, wherein each of the pair of rotating filter holders includes a tab.

5. The ophthalmic device of claim 4, wherein each of the pair of fixed filter holders includes a plurality of indicators arranged along a circumferential direction thereof and wherein the tab has an indicator groove.

6. The ophthalmic device of claim 1, wherein the first pair of polarizing filters includes one or more of anti-reflection coating, scratch-resistance coating, and ultraviolet (UV) blocking coating.

7. The ophthalmic device of claim 1, wherein each of the first pair of polarizing filters is linearly polarized along a first direction and each of the second pair of polarizing filters is linearly polarized along a second direction.

8. The ophthalmic device of claim 7, wherein each of the pair of rotating filter holders is rotatable by at least 90 degrees so that an angle between the first direction and the second direction ranges from 0 to at least 90 degrees.

9. The ophthalmic device of claim 7, wherein the frame includes a pair of fixed filter holders, further comprising:
a third pair of polarizing filters that is secured to the pair of fixed filter holders, respectively.

10. The ophthalmic device of claim 9, wherein each of the third pair of polarizing filters is linearly polarized along a third direction and wherein the first direction is aligned parallel to third direction.

11. The ophthalmic device of claim 9, wherein each of the pair of fixed filter holders includes a slot and wherein each of the pair of rotating filter holders includes a tab that is configured to travel along the slot.

12. The ophthalmic device of claim 11, wherein each of the pair of fixed filter holders includes a plurality of indicators arranged along a circumferential direction thereof and wherein the tab has an indicator groove.

13. The ophthalmic device of claim 9, wherein the third pair of polarizing filters includes one or more of anti-reflection coating, scratch-resistance coating, and ultraviolet (UV) blocking coating.

14. The ophthalmic device of claim 1, wherein the frame includes a pair of lens holders, further comprising:
a pair of prescription lenses that are secured to the pair of lens holders, respectively.

15. The ophthalmic device of claim 14, wherein at least one of the pair of the prescription lenses has a convex curved front surface.

16. The ophthalmic device of claim 14, wherein the pair of prescription lenses includes one or more of anti-reflection coating, scratch-resistance coating, and ultraviolet (UV) blocking coating.

17. The ophthalmic device of claim 14, wherein each of the pair of lens holders includes a slot and wherein each of the pair of rotating filter holders includes a tab that is configured to travel along the slot.

18. The ophthalmic device of claim 17, wherein each of the pair of lens holders includes a plurality of indicators arranged along a circumferential direction thereof and wherein the tab has an indicator groove.

19. The ophthalmic device of claim 1, further comprising:
a pair of eye cups detachably mounted on the frame and configured to block light travelling towards eyes without passing through first pair of polarizing filters.

20. The ophthalmic device of claim 19, wherein each of the pair of eye cups includes a plurality of vents that allows air to pass through without letting light pass through.

21. The ophthalmic device of claim 1, wherein at least one of the first and second pairs of polarizing filters is concave to eyes.
